(19) United States
(12) Patent Application Publication
(10) Pub. No.: US 2016/0376836 A1
(43) Pub. Date: Dec. 29, 2016

(54) WINDOW COVERING

(71) Applicant: LI-MING CHENG, Kaohsiung City (TW)

(72) Inventor: LI-MING CHENG, Kaohsiung City (TW)

(21) Appl. No.: 14/749,139

(22) Filed: Jun. 24, 2015

(51) Int. Cl. E06B 9/262; E06B 9/30

(52) U.S. Cl. CPC E06B 9/262; E06B 9/30

(57) ABSTRACT

A window covering includes an upper rail, a light permeable sheet, a plurality of light impermeable sheets. Each light impermeable sheet at the upper side has the bottom end covered at least the top end of the light impermeable sheet at the lower side so that the light permeable sheet is fully covered. A plurality of connection units also are provided that are connectable respectively to a lower side of the front side of the upper rail, an upper end and a lower end of the front side of each light impermeable sheet, and a rear side of the light permeable sheet facing the light impermeable sheets. When the light impermeable sheets in front of the light permeable sheet are lowered, through the connection units, the light permeable sheet and the light impermeable sheets can be bent to change light permeable zones and light impermeable zones.

### FIELD OF THE INVENTION

The present invention relates to a window covering and particularly to a window covering that can facilitate adjustment of indoor lightness.

### BACKGROUND OF THE INVENTION

A wide variety of window coverings are available on the market these days, such as Venetian blinds, pleated shades, roman shades or the like. They are mainly installed on the doors or windows of houses to block sunshine or serve ornamental purpose. Depending on different consumers' requirements in use the general window covering sheet has to be retracted upward or extended downward through control of a plurality of winding wheels located close to two sides. The winding wheels are located in a trough of an upper rail and wound by a plurality of cords. Winding of the cords is irregular and quite complicated, and difficult to make an orderly arrangement. Hence the conventional window covering generally can only provide limited variations in use, such as retraction or unfolding to selected positions. Trying to make light permeable zones and impermeable zones in a staggered or overlapped manner during the retraction or unfolding process is difficult. Moreover, after the window covering is retracted upward the exposed cords become excessively lengthy and also do not have a winding or concealing design, hence are prone to be used as playing objects by children that could have hazardous concerns such as strangling incident.

### SUMMARY OF THE INVENTION

The primary object of the present invention is to overcome the problems of the conventional window coverings of unable to form staggered or overlapped arrangement of the light permeable zones and impermeable zones through the cords during retraction and unfolding processes, and safety concerns by providing a window covering that can facilitate adjustment of indoor lightness.

To achieve the foregoing object the present invention provides a window covering that includes an upper rail, a light permeable sheet, a plurality of light impermeable sheets and a plurality of connection units. The light permeable sheet is connected to one end of the upper rail. The light impermeable sheets are connected to the light permeable sheet in a spaced manner, and each has a bottom end to cover at least a top end of a lower light impermeable sheet so that the entire light permeable sheet is fully covered. The connection units are connected respectively to a lower side of the front side of the upper rail, an upper end and a lower end of the front side of each light impermeable sheet, and a rear side of the light permeable sheet facing the light impermeable sheets.

In one aspect the light permeable sheet has a plurality of meshes that are arranged regularly or irregularly.

In another aspect each light impermeable sheet has an anchor portion faced the light permeable sheet and connected thereon in a spaced manner and a second pendant weight at one end remote from the anchor portion.

In yet another aspect the anchor portion is stitched to the light permeable sheet, and the first pendant weight is a first stitched hem or includes a first pendant rod added inside the first stitched hem.

In yet another aspect each connection unit is a male Velcro strip and a female Velcro strip that can be engaged with each other, or a hook and an anchor blade with a trough formed thereon latchable by the hook, or a male snap coupler and a female snap coupler that can be coupled together, or a male stretch band and a female stretch band that can be tied together.

In yet another aspect the light permeable sheet has a second pendant weight at the bottom end thereof.

In yet another aspect the second pendant weight is a second stitched hem or includes a second pendant rod added inside the second stitched hem.

By means of the structure set forth above, the invention can provide an efficacy as follow:

Through the connection units when the light impermeable sheets in front of the light permeable sheet are lowered the staggered or overlapped relationship of the light permeable zones and the light impermeable zones can be changed, or the window covering can be retracted to shorten the length thereof, thereby can facilitate adjustment of the indoor lightness.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the window covering of the invention.

FIG. 2 is a perspective view of the window covering of the invention in an assembly condition.

FIG. 3 is a side view of the window covering of the invention.

FIG. 4 is a perspective view for adjustment of the light permeable zone according to the invention.

FIG. 5 is a side view for adjustment of the light permeable zone and the light impermeable zone according to the invention.

FIG. 6 is a side view of the light impermeable zone after retraction.

FIG. 7 is a side view of the window covering after being retracted and wound.

FIG. 8 is a perspective view of another embodiment of the connection unit of the invention.

FIG. 9 is a side view of another embodiment of the connection unit of the invention.

### DETAILED DESCRIPTION OF THE PREFERRED EMBODIMENTS

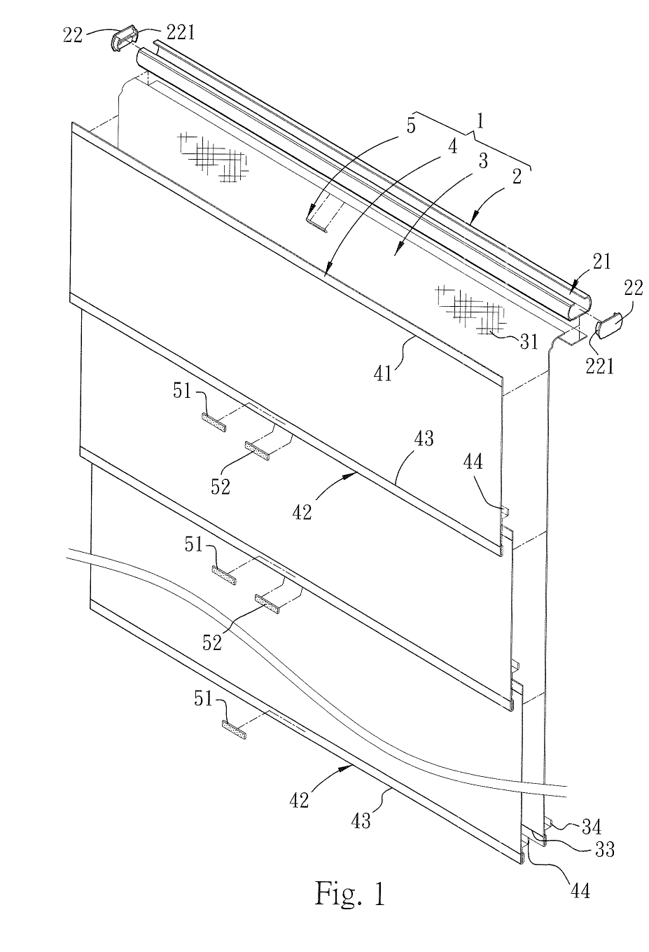

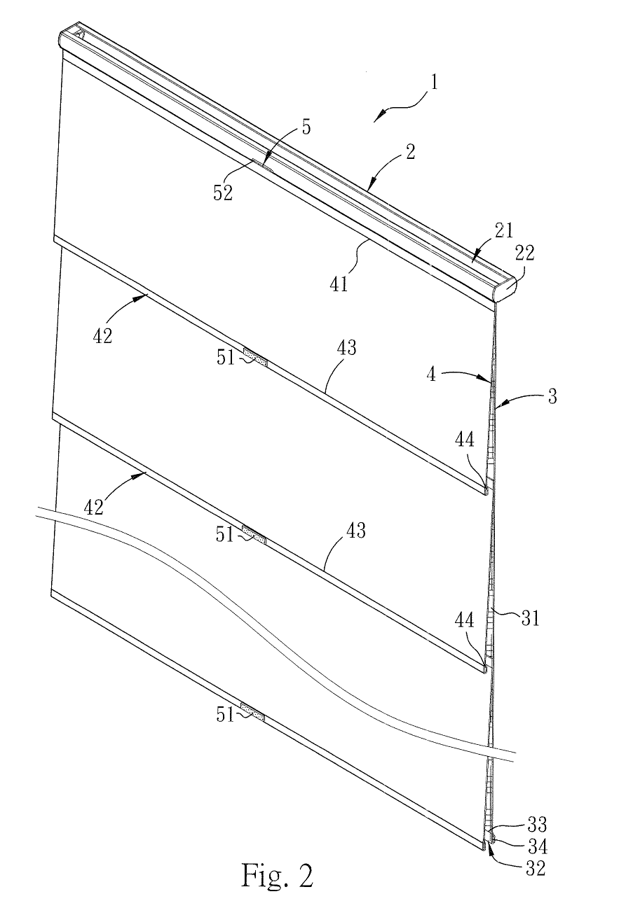

Please referring to FIGS. 1, 2 and 3, the present invention aims to provide a window covering that includes an upper rail 2, a light permeable sheet 3, a plurality of light impermeable sheets 4 and a plurality of connection units 5.

The upper rail 2 has a channel 21 and two sides coupled respectively with a sealing cap 22. Each sealing cap 22 has a wedge boss 221 protruded from the circumference thereof toward each of two ends of the channel 21 to wedge in and cover thereof.

The light permeable sheet 3 is connected to one end of the upper rail 2. More specifically, the light permeable sheet 3 has a plurality of meshes 31 that are arranged regularly or irregularly. The light permeable sheet 3 has a bottom end to form a first pendant weight 32 which is a first stitched hem 33. In this embodiment the first pendant weight 32 includes a first pendant rod 34 added inside the first stitched hem 33.

The light impermeable sheets 4 are arranged in a spaced manner on the light permeable sheet 3 and connected thereon. Moreover, each light impermeable sheet 4 at an upper side has a bottom end to cover at least the top end of a lower light impermeable sheet 4 so that the light permeable sheet 3 is fully covered. More specifically, each light impermeable sheet 4 is a light masking cloth. In this embodiment each light impermeable sheet 4 has an anchor portion 41 faced the light permeable sheet 3 and connected thereon in a spaced manner, and a second pendant weight 42 at one end remote from the anchor portion 41. The anchor portion 41 of each light impermeable sheet 4 is stitched to the light permeable sheet 3, and the second pendant weight 42 is a second stitched hem 43. In this embodiment the second pendant weight 42 includes a second pendant rod 44 added inside the second stitched hem 43.

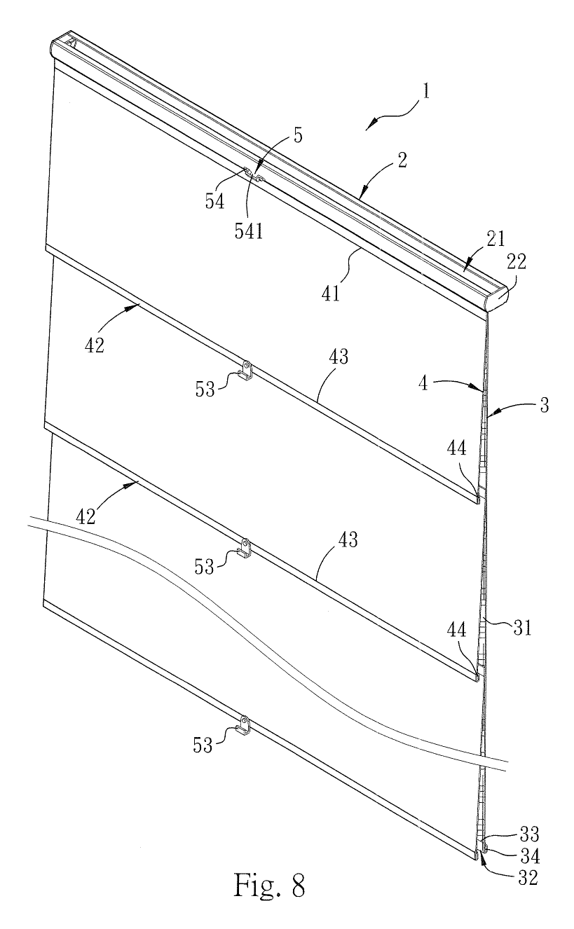

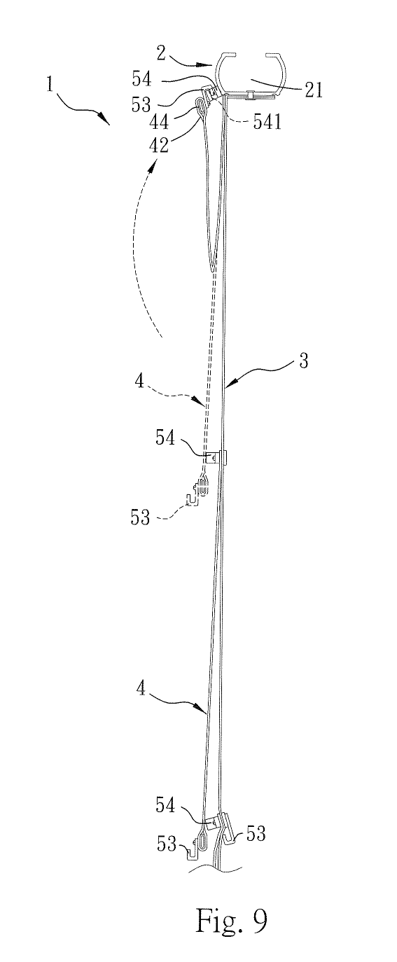

The connection units 5 are connected respectively to a lower side of the front side of the upper rail 2, an upper end and a lower end of the front side of each light impermeable sheet 4, and a rear side of the light permeable sheet 3 facing the light impermeable sheets 4. Thereby a plurality of light permeable zones and a plurality of light impermeable zones can be formed in a staggered or overlapped fashion, or the window covering 1 can be retracted to shorten the length thereof. More specifically, each connection unit 5 and the anchor portion 41 of each light impermeable sheet 4 can be coupled together by bonding, screwing, riveting or stitching. Each connection unit 5 and the second pendant weight 42 also can be coupled together by bonding, screwing, riveting or stitching. Each connection unit 5 and the lower side of the front side of the upper rail 2 also can be coupled together by bonding, screwing, riveting or stitching. And each connection unit 5 and the first pendant weight 32 also can be coupled together by bonding, screwing, riveting or stitching. In this embodiment each connection unit 5 is a male Velcro strip 51 and a female Velcro strip 52 that can be engaged with each other, but this is not the limitation of the invention, other embodiment types also can be employed. Please referring to FIGS. 8 and 9, each connection unit 5 also can be formed via a hook 53 and an anchor blade 54 with a trough 541 formed thereon for latching with each other, or a male snap coupler and a female snap coupler that can be coupled with each other, or a male bonding band and a female bonding band that can be tied together.

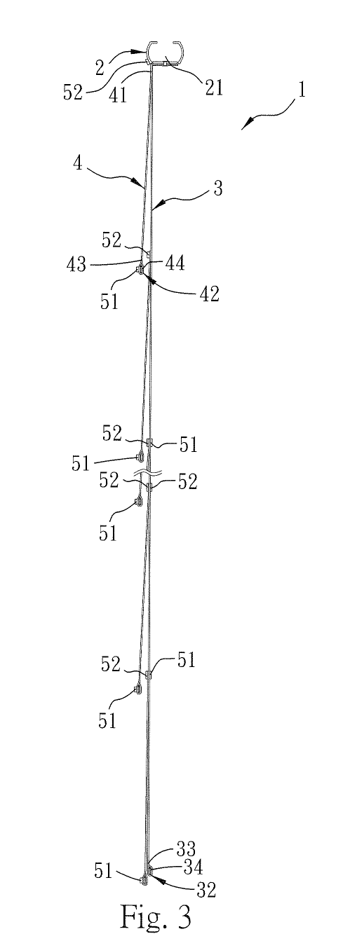

Please also referring to FIG. 3, when the window covering 1 of the invention is in use the bottom end of an upper light impermeable sheet 4 covers at least the top end of a lower impermeable sheet 4, and the entire light permeable sheet 3 is fully covered; through the connection units 5 the light permeable zones and the light impermeable zones can be staggered or overlapped with each other, or the window covering 1 can be retracted to shorten the length thereof to adjust indoor lightness.

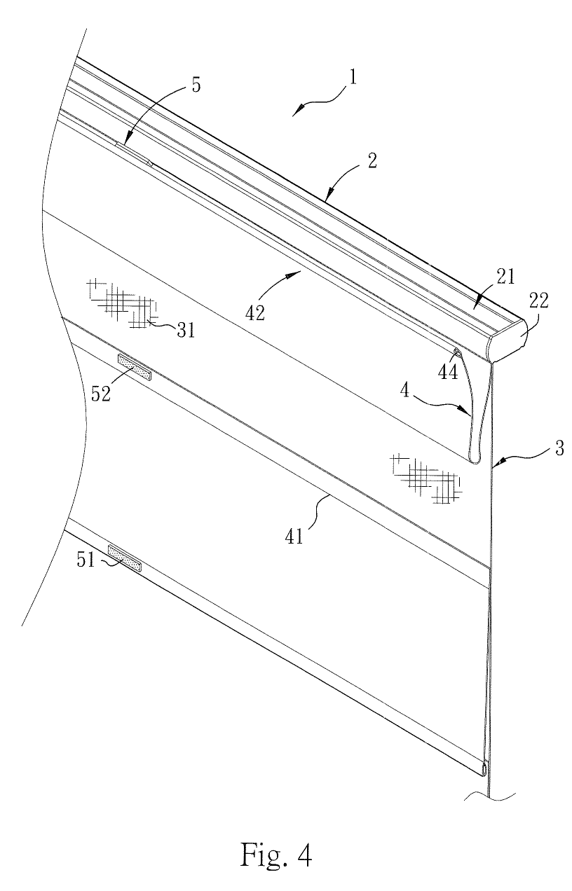

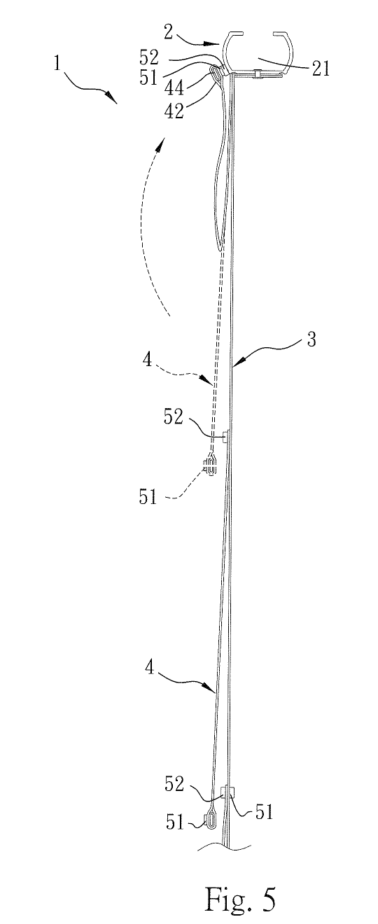

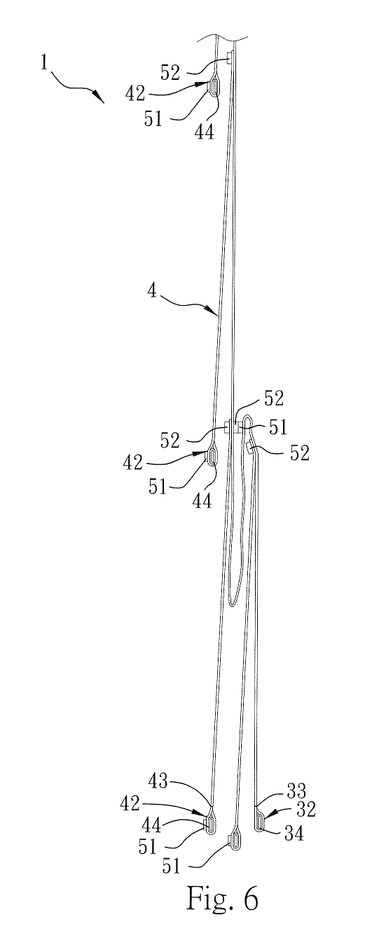

Please referring to FIGS. 4 through 6, in this embodiment the light impermeable sheets 4 in front of the light permeable sheet 3 are positioned and spaced regularly from each other. When in use the male Velcro strip 51 of one connection unit 5 can be bonded to the female Velcro strip 52 of a selected row of the light impermeable sheet 4 depending on the indoor lightness so that the light permeable zones and the light impermeable zones formed by the light impermeable sheets 4 in front of the light permeable sheet 3 are staggered or overlapped to facilitate adjustment of indoor lightness.

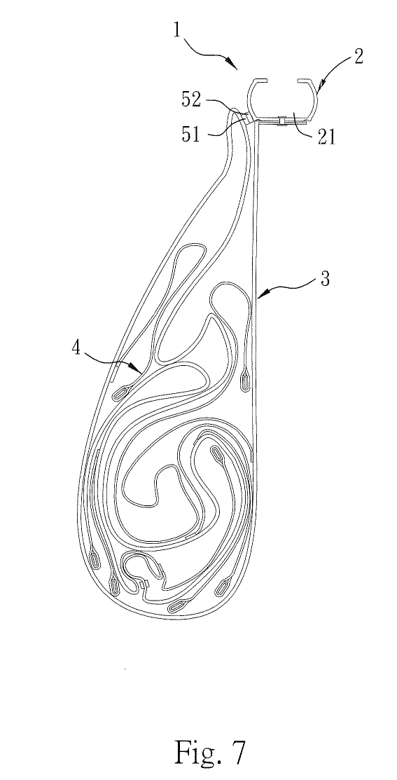

Please referring to FIG. 7, the male Velcro strip 51 at a lower side of the rear side of the light permeable sheet 3 behind the light impermeable sheet 4 can be moved upward to engage with the female Velcro strip 52 of the light permeable sheet 4 at the upper side to shorten the length of the originally pendant window covering 1, and the distal end of the shortened window covering 1 can be rolled upward, as shown in the embodiment depicted in the drawing, with the male Velcro strip 51 in the middle section of the rear side of the light permeable sheet 3 engaged with the female Velcro strip 52 at the lower side of the front side of upper rail 2, then the window covering 1 can be retracted for storing.

What is claimed is:

1. A window covering, comprising:
an upper rail;
a light permeable sheet connected to one end of the upper rail;
a plurality of light impermeable sheets faced the light permeable sheet and connected thereon in a spaced manner, each upper light impermeable sheet including a bottom end to cover at least a top end of a lower light impermeable sheet to fully cover the light permeable sheet; and
a plurality of connection units that are connectable respectively to a lower side of a front side of the upper rail, an upper end and a lower end at a front side of each light impermeable sheet, and a rear side of the light permeable sheet facing the light impermeable sheets to form a plurality of light permeable zones and a plurality of light impermeable zones in a staggered or overlapped fashion, and make the window covering retractable to shorten the length thereof.

2. The window covering of claim 1, wherein the light permeable sheet includes a plurality of meshes that are selectively arranged in a regular or irregular fashion.

3. The window covering of claim 1, wherein each light impermeable sheet includes an anchor portion faced the light permeable sheet and spaced from each other and a second pendant weight at one end remote from the anchor portion.

4. The window covering of claim 3, wherein the anchor portion of each light impermeable sheet is stitched to the light permeable sheet, the second pendant weight being a second stitched hem or a second pendant rod added inside the second stitched hem.

5. The window covering of claim 1, wherein each connection unit is selectively a male Velcro strip and a female Velcro strip that are engageable with each other, a hook and an anchor blade which includes a trough formed thereon latchable by the hook, a male snap coupler and a female snap coupler that are latchable with each other, or a male bonding band and a female bonding band that are tyable with each other.

6. The window covering of claim 1, wherein the light permeable sheet includes a first pendant weight at a bottom end thereof.

7. The window covering of claim 6, wherein the first pendant weight is a first stitched hem or a first pendant rod added inside the first stitched hem.
